(19) United States
(12) Patent Application Publication
(10) Pub. No.: US 2025/0139901 A1
(43) Pub. Date: May 1, 2025

(54) DISTRIBUTION CONTROL APPARATUS, TERMINAL, DISTRIBUTION CONTROL SYSTEM, DISTRIBUTION CONTROL METHOD, AND PROGRAM

(71) Applicant: NIPPON TELEGRAPH AND TELEPHONE CORPORATION, Tokyo (JP)

(72) Inventors: Xiaotian ZHAO, Tokyo (JP); Takafumi OKUYAMA, Tokyo (JP)

(21) Appl. No.: 18/836,952

(22) PCT Filed: Mar. 28, 2022
(86) PCT No.: PCT/JP2022/015199

§ 371 Date: Aug. 8, 2024

(51) Int. Cl. G06T 17/20; G06T 15/20; H04N 21/239; H04N 21/81

(52) U.S. Cl. CPC G06T 17/205; G06T 15/20; G06T 2210/08; G06T 2210/36; H04N 21/2393; H04N 21/816

(57) ABSTRACT

A distribution control device includes a first creation unit configured to create, for each of a plurality of virtual viewpoints arranged for an object represented by 3D data constituting 3D video content, one-sided 3D data in which an amount of data of a portion of the object that cannot be visually recognized from the virtual viewpoint is reduced, and a distribution unit configured to distribute data including a mesh and a texture as one-sided 3D data of one virtual viewpoint among the one-sided 3D data for each of the virtual viewpoints to a terminal of a user according to a viewing angle of the user in a virtual space where the object is arranged.

### TECHNICAL FIELD

The present invention relates to a distribution control device, a terminal, a distribution control system, a distribution control method, and a program.

### BACKGROUND ART

3D video content having six degrees of freedom (6Dof) represented by volumetric video, holograms, and the like is known. In order to distribute such content with high quality through a communication network, it is necessary to control the distribution of the content itself in addition to using a high data compression technique and a load distribution technique of a communication network/system. In particular, it is important to dynamically control the distribution of content in accordance with visual field information of an XR (VR/AR/MR/SR) device serving as a client, position information of a user in a virtual space, and the like.

A volumetric video is animation data composed of polygon meshes (hereinafter simply referred to as “mesh”) and textures, and can be displayed and viewed on a display by rendering together with a virtual environment on the client side.

A technique described in Non-Patent Literature 1 is known as a volumetric video distribution technique. Non-Patent Literature 1 proposes a method of rendering a volumetric video on the server side based on head movement of a user detected by an AR/VR device which is a client, and transmitting the rendered volumetric video to the client as 2D data.

### CITATION LIST

### Non-Patent Literature

Non-Patent Literature 1: Serhan Gul, Dimitri Podborski, Thomas Buchholz, Thomas Schierl and Cornelius Hellge, “Low-latency cloud-based volumetric video streaming using head motion prediction”, NOSSDAV ′20: Proceedings of the 30th ACM Workshop on Network and Operating Systems Support for Digital Audio and Video, June 2020, Pages 27-33

### SUMMARY OF INVENTION

### Technical Problem

Since a volumetric video has a large amount of data and a large bandwidth of a communication network is necessary for the distribution thereof, there is a demand for a method of efficiently distributing a volumetric video.

However, in the prior art, it is necessary to transmit data of 3 or more dimensions in order to distribute a video with presence, and large amounts of data capacity and processing time are required. In addition, although there is a technique for compressing data, there is a problem that high presence viewing cannot be performed because quality deterioration occurs. Further, there is a problem that an excessive load is applied to the center server to which many terminals are connected for processing.

The disclosed technique has an object of reducing a processing load in a server that controls distribution of 3D video content.

### Solution to Problem

The technology of the disclosure is a distribution control device including a first creation unit configured to create, for each of a plurality of virtual viewpoints arranged for an object represented by 3D data constituting 3D video content, one-sided 3D data in which an amount of data of a portion of the object that cannot be visually recognized from the virtual viewpoint is reduced, and a distribution unit configured to distribute data including a mesh and a texture as one-sided 3D data of one virtual viewpoint among the one-sided 3D data for each of the virtual viewpoints to a terminal of a user according to a viewing angle of the user in a virtual space where the object is arranged.

### Advantageous Effects of Invention

The load of processing in a server for controlling the distribution of the 3D video content can be reduced.

### BRIEF DESCRIPTION OF DRAWINGS

FIG. 1 is a diagram illustrating an example of an overall configuration of a distribution control system according to the present embodiment.

FIG. 2 is a flowchart illustrating an example of one-sided 3D data creation processing according to the present embodiment.

FIG. 3 is a diagram illustrating an arrangement example of virtual viewpoints.

FIG. 4 is a flowchart illustrating one example of reproduction processing according to the present embodiment.

FIG. 5 is a first diagram illustrating an example of a manifest file.

FIG. 6 is a second diagram illustrating an example of a manifest file.

FIG. 7 is a diagram illustrating an example of an arrangement folder of the manifest file.

FIG. 8 is a diagram illustrating an example of an arrangement folder of one-sided 3D data.

FIG. 9 is a diagram illustrating an example of an arrangement folder of an mtl file.

FIG. 10 is a diagram illustrating an example of an arrangement folder of a texture file.

FIG. 11 is a diagram illustrating an example of a setting file.

FIG. 12 is a third diagram illustrating an example of a configuration of a lightning protection device according to the present embodiment.

FIG. 13 is a diagram illustrating one example of a hardware configuration of a computer.

### DESCRIPTION OF EMBODIMENTS

An embodiment of the present invention (the present embodiment) will be described below with reference to the drawings. The embodiments which will be described below are merely examples and embodiments to which the present invention is applied are not limited to the following embodiments.

In the present embodiment, a distribution control system 1 that targets volumetric video as an example of 3D video content and can reduce the amount of data required for distribution while maintaining the user's perceived quality will be described. Here, the volumetric video is animation data composed of 3D data (also referred to as three-dimensional data or three-dimensional data) represented by meshes and textures. That is, for example, if 3D data of a frame at time t is denoted by dₜ, the volumetric video is represented as {dₜ|t∈[tₛ, tₑ]}. tₛ denotes the start time of the volumetric video, and tₑ denotes the end time.

The embodiments described below are not limited to the volumetric video, and can be similarly applied to, for example, 3D video content with six degrees of freedom such as a hologram.

### Overall Configuration

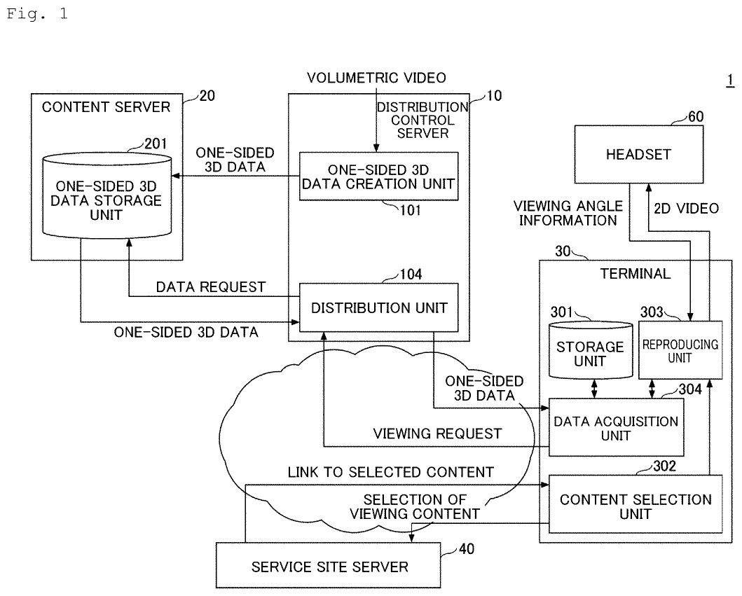

First, an overall configuration of a distribution control system according to the present embodiment will be described with reference to FIG. 1.

FIG. 1 is a diagram illustrating an example of an overall configuration of the distribution control system according to the present embodiment. A distribution control system 1 includes a distribution control server 10, a content server 20, a terminal 30, a service site server 40, and a headset 60. The distribution control server 10 and the terminal 30 are communicatively connected via a communication network such as the Internet. Similarly, the terminal 30 and the service site server 40 are communicatively connected via the communication network.

It is assumed that the distribution control server 10 and the content server 20 are on the same local network and are communicatively connected on the local network, but the present invention is not limited thereto, and for example, they may be communicatively connected via the communication network.

The distribution control server 10 creates a plurality of pieces of one-sided 3D data from 3D data constituting the given volumetric video, and stores the plurality of pieces of one-sided 3D data in the content server 20. Here, the one-sided 3D data is three-dimensional data for when an object represented by 3D data constituting the volumetric video is viewed from one viewpoint, and is data of which the amount is reduced more than that of the original 3D data while the quality of experience of a user is maintained. The object is a subject of a volumetric video, and can be any object that can be represented by meshes and textures, such as a person, animal, plant, structure, building, machine, celestial body, natural phenomenon, or the like.

In addition, in response to a viewing request from the terminal 30, the distribution control server 10 determines appropriate one-sided 3D data from the viewpoint, a spatial position, a field of view (a line-of-sight direction and a field-of-view range), or the like of the user, and distributes this one-sided 3D data to the terminal 30. The viewpoint and the spatial position of the user are the position of the user in a virtual space in which the object is arranged.

The content server 20 stores a plurality of pieces of one-sided 3D data. In response to a data request from the distribution control server 10, the content server 20 returns one-sided 3D data corresponding to the data request to the distribution control server 10.

The terminal 30 is any of various terminals (for example, XR (VR/AR/MR/SR, or the like) devices, or the like) used by a user who views the volumetric video, and renders the one-sided 3D data distributed from the distribution control server 10 and reproduces the volumetric video. Note that XR device includes not only head mount displays (HMDs) but also smartphones, tablet terminals, wearable devices, or the like on which application programs functioning as XR devices are installed.

When the user views the volumetric video, for example, the following procedure is performed. First, the user accesses the service site server 40 through the terminal 30, and acquires a list of content (volumetric videos) that the user can view. Then, the user selects a volumetric video that they desire to view from the list and obtains a link to the selected volumetric video. When the terminal 30 accesses the link, a viewing request is transmitted to the distribution control server 10, and reproduction of the volumetric video is started by returning one-sided 3D data to the request.

Specifically, the terminal 30 includes a storage unit 301, a content selection unit 302, a reproduction unit 303, and a data acquisition unit 304. These units are implemented by, for example, one or more programs installed in the terminal 30 causing a processor such as a central processing unit (CPU) to execute processing.

The storage unit 301 stores a manifest file arranged in advance, and one-sided 3D data, an mtl file, a texture file and the like transmitted from the distribution control server 10. The manifest file is a file in which the relation between the viewing angle and the one-sided 3D data is regulated. The mtl file is a file that describes how to render textures.

The content selection unit 302 receives selection of content by a user from a list of viewable content (volumetric videos), and links a link to the selected volumetric video to the reproduction unit 303.

The reproduction unit 303 reproduces the volumetric video based on the link to the selected volumetric video. Specifically, the reproduction unit 303 acquires information (viewing angle information) indicating a viewing angle from the headset 60, and requests the data acquisition unit 304 to acquire the one-sided 3D data, the mtl file and the texture file necessary for reproduction of the volumetric video in cooperation with the acquired viewing angle information.

The reproduction unit 303 renders a texture on the one-sided 3D data based on the data obtained as the response, and transmits the 2D video to the headset 60. Thus, the headset 60 can display the received 2D video.

A data acquisition unit 304 refers to the manifest file and acquires the one-sided 3D data, the mtl data, and the texture file of a necessary angle from the distribution control server 10 based on the viewing angle information.

The service site server 40 presents a list of content (volumetric videos) that the user can view, and provides a link to the content selected from the list to the terminal 30.

The distribution control server 10 includes a one-sided 3D data creation unit 101 and a distribution unit 104. These units are implemented by, for example, one or more programs installed in the distribution control device 10 causing a processor such as a central processing unit (CPU) to execute processing.

The one-sided 3D data creation unit 101 creates a plurality of pieces of one-sided 3D data from 3D data constituting the volumetric video given to the distribution control server 10. More specifically, the one-sided 3D data creation unit 101 creates one-sided 3D data by arranging a plurality of virtual viewpoints at equal intervals (or unequal intervals) around an object represented by 3D data constituting the volumetric video, and then performing geometry simplification processing (level of detail reduction processing) on the mesh corresponding to the back surface of the object when the object is viewed from the virtual viewpoint for each virtual viewpoint. In this way, by performing the geometry simplification for the mesh of the back surface (that is, a part invisible from the virtual viewpoint) of the object represented by the 3D data for each virtual viewpoint, the one-sided 3D data is created for each virtual viewpoint.

Then, the one-sided 3D data creation unit 101 stores the plurality of pieces of created one-sided 3D data in the content server 20.

The distribution unit 104 transmits the one-sided 3D data to the terminal 30 in response to a request from the terminal 30.

In addition, the content server 20 includes a one-sided 3D data storage unit 201. The one-sided 3D data storage unit 201 is implemented by an auxiliary storage device such as an HDD or an SSD.

The one-sided 3D data storage unit 201 stores each piece of one-sided 3D data created by the one-sided 3D data creation unit 101.

Note that the configuration of the distribution control system 1 illustrated in FIG. 1 is an example, and another configuration may be used. For example, the distribution control server 10 and the content server 20 may be constituted as an integral server.

### Details of Various Types of Processing

Hereinafter, each processing of one-sided 3D data creation processing for creating a plurality of pieces of one-sided 3D data and reproduction processing for the terminal 30 to reproduce appropriate one-side 3D data will be described. Note that the one-sided 3D data creation processing is a pre-processing executed before the reproduction processing.

### One-Sided 3D Data Creation Processing

First, the one-sided 3D data creation processing will be described.

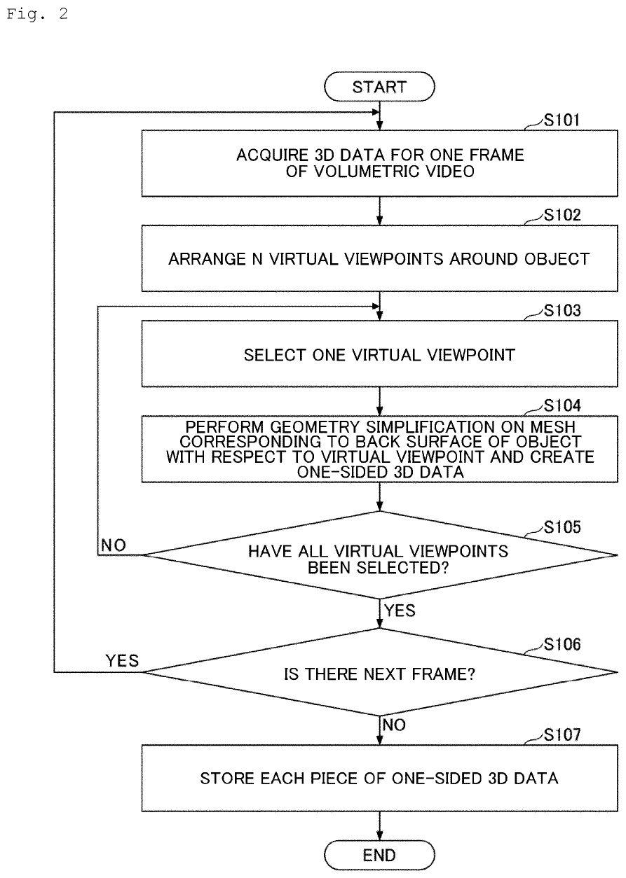

FIG. 2 is a flowchart illustrating an example of one-sided 3D data creation processing according to the present embodiment. In the following description, it is assumed that the volumetric video is given to the distribution control server 10.

The one-sided 3D data creation unit 101 acquires 3D data for one frame from among 3D data constituting the volumetric video (step S101). In the following description, it is assumed that the one-sided 3D data creation unit 101 acquires 3D data dₜ of a frame at time t. The initial value of t only needs to be t=tₛ.

Although the 3D data is composed of meshes and textures, since the textures are not particularly processed below, only the meshes of the 3D data may be acquired in step S101.

Next, the one-sided 3D data creation unit 101 arranges N virtual viewpoints around the object represented by the 3D data dₜ acquired in step S102 above (step S102). However, it is assumed that the line-of-sight direction of each virtual viewpoint is an object. For example, the one-sided 3D data creation unit 101 arranges N virtual viewpoints with the object in the line-of-sight direction at equal intervals (or unequal intervals) on a circumference of a circle having a predetermined radius with the object as a center. Note that N is a predetermined integer of 2 or more.

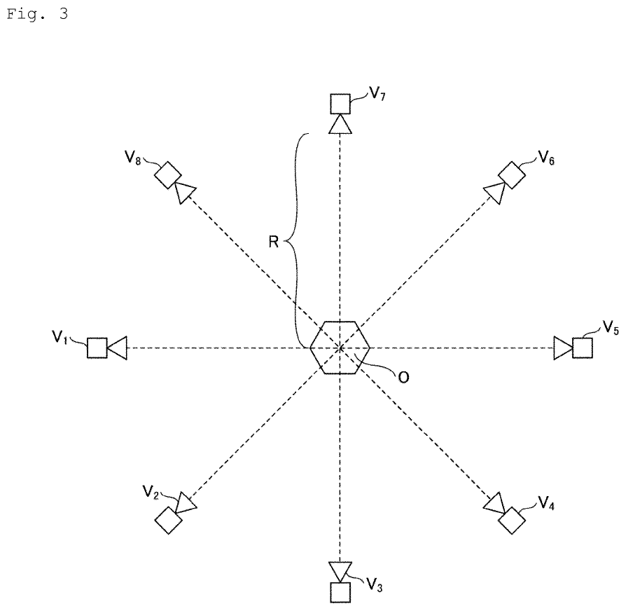

FIG. 3 is a diagram illustrating an arrangement example of virtual viewpoints. FIG. 3 illustrates an example of arrangement of virtual viewpoints when N=8. In the arrangement example illustrated in FIG. 3, virtual viewpoints V₁ to V₈ with an object O in the line-of-sight direction are arranged at equal intervals on a circumference of a circle having a radius R with the object O as a center.

It is to be noted that the virtual viewpoints are arranged on a circumference of a circle by way of example, and the present invention is not limited thereto, and for example, the virtual viewpoints may be arranged on the side or the vertex of a polygon with the object as the center. In the example illustrated in FIG. 3, for simplicity, the virtual viewpoints V₁ to V₈ are arranged on the xy plane of the xyz space with the center of the object O as an origin, but the present invention is not limited thereto, and for example, virtual viewpoints may be arranged on a spherical surface (or a polyhedron) with the origin as a center.

Next, the one-sided 3D data creation unit 101 selects one virtual viewpoint from among the N virtual viewpoints arranged in step S102 (step S103).

Next, when the object is viewed from the virtual viewpoint selected in step S103, the one-sided 3D data creation unit 101 performs geometry simplification processing (level of detail reduction processing) on a mesh corresponding to the back surface of the object (step S104). In other words, the one-sided 3D data creation unit 101 performs geometry simplification processing on a mesh of a part which cannot be visually recognized (not visible) from the virtual viewpoint among meshes constituting the object. Thus, when the object is viewed from the virtual viewpoint, the quality of experience equivalent to the original 3D data dₜ can be obtained, and one-sided 3D data in which the amount of data is reduced more than that of the original 3D data dₜ can be created.

Next, the one-sided 3D data creation unit 101 determines whether or not all the N virtual viewpoints have been selected (step S105).

When it is determined in step S105 that there is a virtual viewpoint that has not been selected yet, the one-sided 3D data creation unit 101 returns to step S103, selects one virtual viewpoint from among the virtual viewpoints that have not been selected yet, and executes processing after step S104.

On the other hand, when it is determined that all the N virtual viewpoints have been selected in step S105, the one-sided 3D data creation unit 101 determines whether or not there is a next frame in the given volumetric video (step S106).

When it is determined in step S106 that there is a next frame, the one-sided 3D data creation unit 101 returns to step S101, acquires 3D data of the next frame, and executes processing after step S102. That is, in this case, the one-sided 3D data creation unit 101 returns to step S101 as t←t+1, and acquires the 3D data dₜ of the frame at the next time t.

On the other hand, when it is determined that there is no next frame in step S106 (that is, when time t=tₑ), a one-sided 3D data creation unit 101 stores each piece of one-sided 3D data created in step S104 in the one-sided 3D data storage unit 201 of the content server 20 (step S107). Thus, for example, if one-sided 3D data corresponding to a viewpoint Vᵢ (where i∈[1, N]) at time t is denoted by dₜᵢ, the set of one-sided 3D data {dₜᵢ|t∈[tₛ, tₑ], i∈[1, N]} is stored in the one-sided 3D data storage unit 201.

### Reproduction Processing

Next, the flow of the reproduction processing by the terminal 30 will be described.

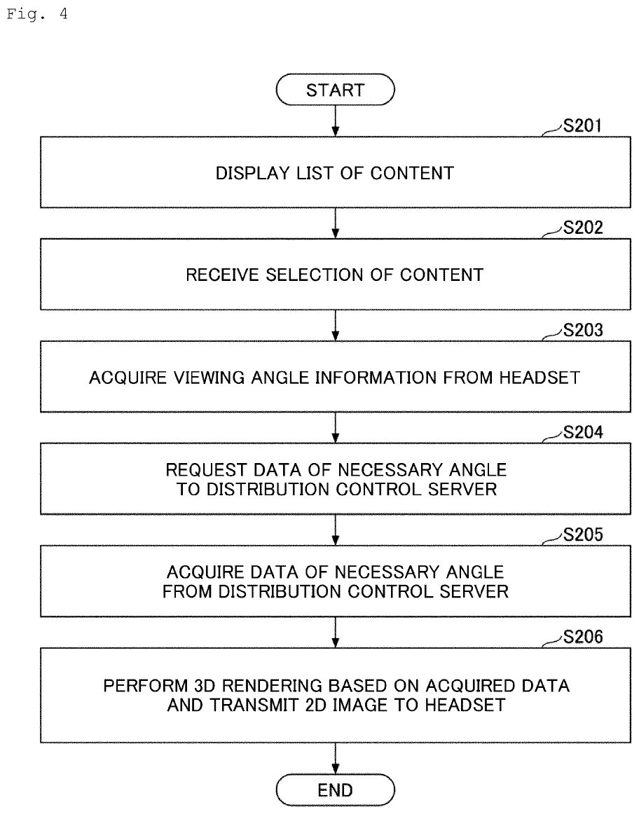

FIG. 4 is a flowchart illustrating an example of the reproduction processing according to the present embodiment. The content selection unit 302 displays a list of content obtained from the service site server (step S201). Then, the content selection unit 302 receives selection of the content (step S202).

The reproduction unit 303 acquires viewing angle information from the headset 60 (step S203). The data acquisition unit 304 requests data of a necessary angle to a distribution control server (step S204). The data acquisition unit 304 acquires the data of the necessary angle from the distribution control server (step S205).

A reproduction unit 303 performs 3D rendering based on the acquired data and transmits the 2D video to the headset (step S206).)

### Details of Various Types of Processing

Hereinafter, various types of data pieces handled in the present embodiment will be described in detail.

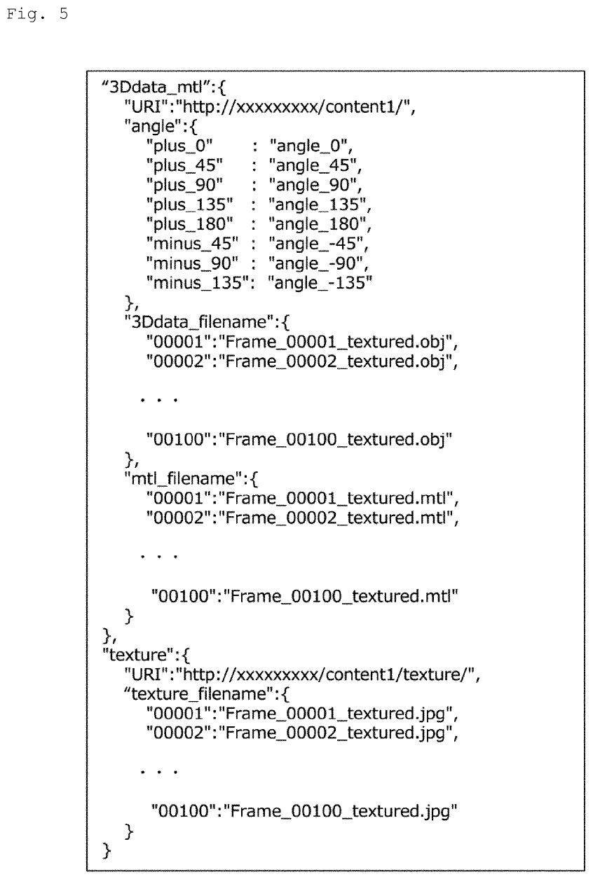

FIG. 5 is a first diagram illustrating an example of a manifest file. In the manifest file, the correspondence between the required angle and the one-sided 3D data is shown as an array. The necessary angle is indicated by the difference from the reference angle (for example, 0 degrees). In the example illustrated in FIG. 5, in a case of acquiring one-sided 3D data of 0 degree as a reference, json [“angle”][“plus_0”] is designated, and in a case of acquiring one-sided 3D data of 45 degrees, json [“angle”][“plus_45”] is designated.

Also, in a case of acquiring “Frame_00001_textured.obj” of one-sided 3D data, json [“3Ddata_filename”][“00001”] is designated, and in a case of acquiring “Frame_00002_textured. jpg” of the texture, json [“texture”][“texture_filename”][“00002”] may be designated.

In a case where there are a plurality of content items, a plurality of manifest files may be prepared.

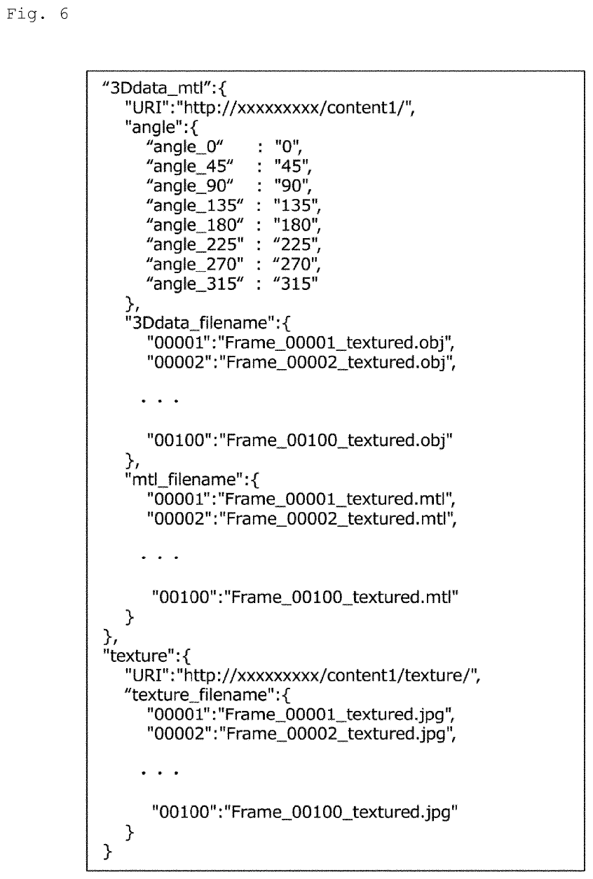

FIG. 6 is a second diagram illustrating an example of a manifest file. In the example illustrated in FIG. 6, the necessary angles are indicated by the absolute angles in the reference coordinate system. For example, in a case of acquiring the one-sided 3D data of 0 degrees, [“angle”] and [“angle_0”] are designated, and in a case of acquiring one-sided 3D data of 45 degrees, [“angle”] and [“angle_45”] are designated.

The data acquisition unit 304 acquires data by referring to such a manifest file in step S205 of reproduction processing. Specifically, in a case where there is no folder of the content name received from the reproduction unit 303, the data acquisition unit 304 creates the following folder.

[Content name]/[Angle name] [Content name]/texture

In addition, in a case where there is no corresponding file in the folder, the data acquisition unit 304 acquires three files of the 3D data, the mtl file, and the texture file based on the manifest file from the distribution control server 10. Then, the data acquisition unit 304 returns the acquired file path to the reproduction unit 303. The file path to be returned is as follows.

[Content name]/[Angle name]/[File name (no extension)]

The file acquired by the data acquisition unit 304 is stored in the storage unit 301.

A specific example of various files stored in the storage unit 301 in a case where the content name is “video 1” will be described below.

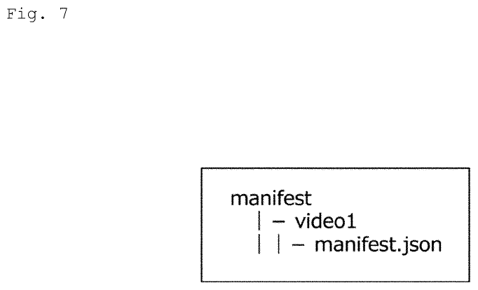

FIG. 7 is a diagram illustrating an example of an arrangement folder of the manifest file. The manifest file is arranged in a folder for each content name determined in advance in the storage unit 301.

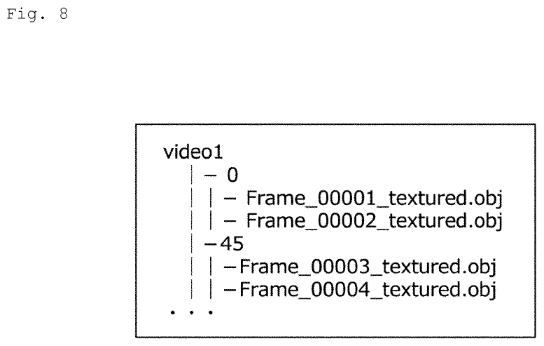

FIG. 8 is a diagram illustrating an example of an arrangement folder of one-sided 3D data. In the storage unit 301, the one-sided 3D data are arranged as files for each angle in a folder for each content name.

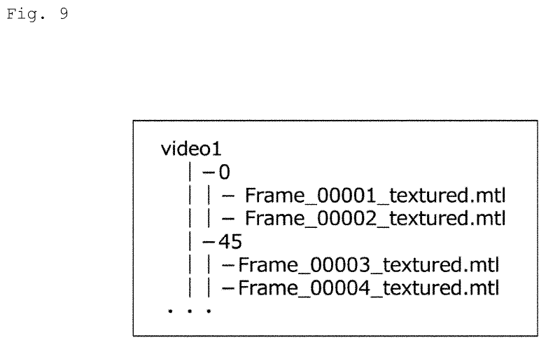

FIG. 9 is a diagram illustrating an example of the arrangement folder of the mtl file. In the storage unit 301, the mtl file is arranged in a folder for each content name for each angle, similarly to the one-sided 3D data.

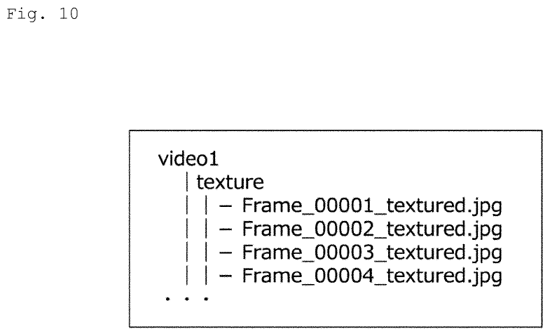

FIG. 10 is a diagram illustrating an example of an arrangement folder of a texture file. In the storage unit 301, the texture file is arranged in a folder for each content name.

In addition, the parent folder of a folder to be downloaded is described in a setting file referred to by the reproduction unit 303. In a case of reproducing the downloaded file, the reproduction unit 303 reads out the setting file and generates a full path of the folder.

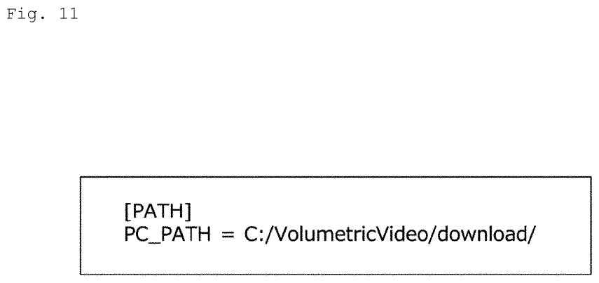

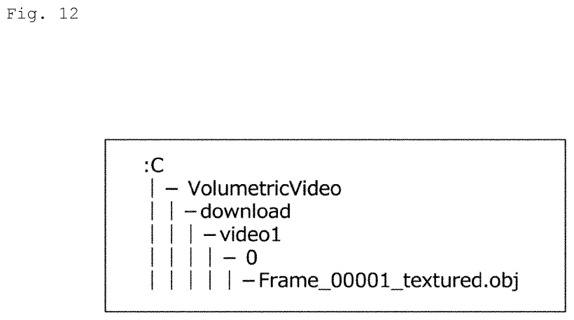

FIG. 11 is a diagram illustrating an example of a setting file. In addition, FIG. 12 is a diagram illustrating an example of a folder configuration. FIG. 12 illustrates a folder configuration corresponding to the setting file illustrated in FIG. 11.

In this case, the reproduction unit 303 creates a full path of “C:/VolumetricVideo/download/video1/0/Frame 00001_tex tured obj” in combination of “C:/VolumetricVideo/download/” described in the setting file, and the file name of downloaded one-side 3D data “video1/0/Frame_00001_textured” and the “extension”.

### Hardware Configuration

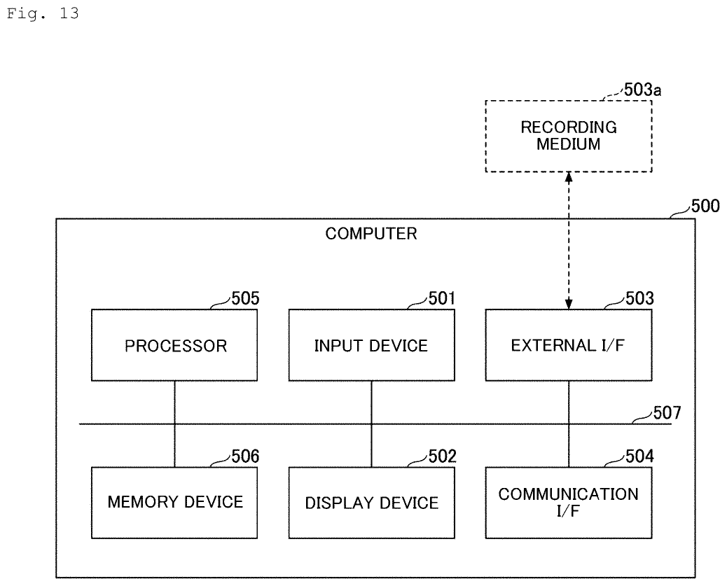

Finally, hardware configurations of the distribution control server 10 and the content server 20 according to the present embodiment will be described. The distribution control server 10 and the content server 20 according to the present embodiment are implemented by, for example, a hardware configuration of a computer 500 illustrated in FIG. 13. The terminal 30 and the service site server 40 may also be implemented in a similar hardware configuration.

The computer 500 illustrated in FIG. 13 includes an input device 501, a display device 502, an external I/F 503, a communication I/F 504, a processor 505, and a memory device 506. Each of these pieces of hardware is communicatively connected via a bus 507.

The input device 501 is, for example, a keyboard, a mouse, or a touch panel. The display device 502 is, for example, a display. The computer 500 may not include at least one of the input device 501 and the display device 502.

An external I/F 503 is an interface with an external device such as a recording medium 503a. Examples of the recording medium 503a include a compact disc (CD), a digital versatile disk (DVD), a secure digital memory card (SD memory card), a universal serial bus (USB) memory card, and so forth.

The communication I/F 504 is an interface for performing data communication with other devices, devices, systems, and the like. The processor 505 is, for example, various arithmetic devices such as a CPU. The memory device 506 is, for example, any of various storage devices such as an HDD, an SSD, a random access memory (RAM), a read only memory (ROM), and a flash memory.

The distribution control server 10 and the content server 20 according to the present embodiment can implement various types of processing described above by having the hardware configuration of the computer 500 illustrated in FIG. 13. Note that the hardware configuration of the computer 500 illustrated in FIG. 13 is an example, and the computer 500 may have other hardware configurations. For example, the computer 500 may include a plurality of processors 505 or a plurality of memory devices 506.

According to the distribution control system 1 according to the present embodiment, the terminal 30 renders texture on the one-sided 3D data distributed from the distribution control server 10, and converts the texture into a 2D image. Thus, the processing load of the distribution control server 10 can be reduced, compared with a configuration in which the distribution control server 10 distributes after rendering texture in real time.

### SUMMARY OF EMBODIMENT

This specification describes at least a distribution control device, a terminal, a distribution control system, a distribution control method, and a program described in each clause below.

### Clause 1

A distribution control device including
a first creation unit configured to create, for each of a plurality of virtual viewpoints arranged for an object represented by 3D data constituting 3D video content, one-sided 3D data in which an amount of data of a portion of the object that cannot be visually recognized from the virtual viewpoint is reduced, and a distribution unit configured to distribute data including a mesh and a texture as one-sided 3D data of one virtual viewpoint among the one-sided 3D data for each of the virtual viewpoints to a terminal of a user according to a viewing angle of the user in a virtual space where the object is arranged.

### Clause 2

The distribution control device according to clause 1, in which the first creation unit is configured to create one-sided 3D data in which the amount of data of a portion that cannot be visually recognized from the virtual viewpoint is reduced by performing geometry simplification processing on a polygon mesh representing the portion. function.

### Clause 3

The distribution control device according to clause 1 or 2, in which the portion that cannot be visually recognized from the virtual viewpoint is a portion corresponding to a back surface of the object when the object is viewed from the virtual viewpoint.

### Clause 4

A terminal includes a data acquisition unit configured to acquire data including a mesh and a texture as one-sided 3D data from a server that controls distribution based on information specifying a relationship between a viewing angle and the one-sided 3D data, and
a reproduction unit configured to render the texture on the mesh to reproduce a video.

### Clause 5

A distribution control system including a distribution control device and a terminal, wherein the distribution control device includes a first creation unit configured to create, for each of a plurality of virtual viewpoints arranged for an object represented by 3D data constituting 3D video content, one-sided 3D data in which an amount of data of a portion of the object that cannot be visually recognized from the virtual viewpoint is reduced, and a distribution unit configured to distribute data including a mesh and a texture as one-sided 3D data of one virtual viewpoint among the one-sided 3D data for each of the virtual viewpoints to the terminal according to a viewing angle of a user in a virtual space where the object is arranged, and the terminal includes
a data acquisition unit configured to acquire data including the mesh and the texture as the one-sided 3D data from a server that controls distribution based on information specifying a relationship between the viewing angle and the one-sided 3D data, and
a reproduction unit configured to render the texture on the mesh to reproduce a video.

### Clause 6

A distribution control method executed by a computer, the method including
a step of creating, for each of a plurality of virtual viewpoints arranged for an object represented by 3D data constituting 3D video content, one-sided 3D data in which an amount of data of a portion of the object that cannot be visually recognized from the virtual viewpoint is reduced, and
a step of distributing data including a mesh and a texture as one-sided 3D data of one virtual viewpoint among the one-sided 3D data for each of the virtual viewpoints to a terminal of a user according to a viewing angle of the user in a virtual space where the object is arranged.

### Clause 7

A program for causing a computer to function as each unit of the distribution control device according to any one of clauses 1 to 3 or the terminal according to clause 4.

Although the present embodiment has been described above, the present invention is not limited to such a specific embodiment and various modifications and changes can be made within the scope of the gist of the present invention described in the claims.

### REFERENCE SIGNS LIST

10 Distribution control server
20 Content server
30 Terminal
40 Service site server
60 Headset
101 One-sided 3D data creation unit
104 Distribution unit
201 One-sided 3D data storage unit
301 Storage unit
302 Content selection unit
303 Reproducing unit
304 Data acquisition unit
500 Computer
501 Input device
502 Display device
503 External I/F
503a Recording medium
504 Communication I/F
505 Processor
506 Memory device
507 Bus

1. A distribution control device comprising:
a processor; and
a memory storing program instructions that cause the processor to:
create, for each of a plurality of virtual viewpoints arranged for an object represented by 3D data constituting 3D video content, one-sided 3D data in which an amount of data of a portion of the object that cannot be visually recognized from the virtual viewpoint is reduced; and
distribute data including a mesh and a texture as one-sided 3D data of one virtual viewpoint among the one-sided 3D data for each of the virtual viewpoints to a terminal of a user according to a viewing angle of the user in a virtual space where the object is arranged.

2. The distribution control device according to claim 1, wherein the program instructions cause the processor to create one-sided 3D data in which the amount of data of a portion that cannot be visually recognized from the virtual viewpoint is reduced by performing geometry simplification processing on a polygon mesh representing the portion.

3. The distribution control device according to claim 1, wherein the portion that cannot be visually recognized from the virtual viewpoint is a portion corresponding to a back surface of the object when the object is viewed from the virtual viewpoint.

4. A terminal comprising:
a processor; and
a memory storing program instructions that cause the processor to:
acquire data including a mesh and a texture as one-sided 3D data from a server that controls distribution based on information specifying a relationship between a viewing angle and the one-sided 3D data; and
render the texture on the mesh to reproduce a video.

5. (canceled)

6. A distribution control method executed by a computer, the method comprising:
creating, for each of a plurality of virtual viewpoints arranged for an object represented by 3D data constituting 3D video content, one-sided 3D data in which an amount of data of a portion of the object that cannot be visually recognized from the virtual viewpoint is reduced; and
distributing data including a mesh and a texture as one-sided 3D data of one virtual viewpoint among the one-sided 3D data for each of the virtual viewpoints to a terminal of a user according to a viewing angle of the user in a virtual space where the object is arranged.

7. A non-transitory computer-readable recording medium having stored therein a program for causing a computer to perform the distribution control method according to claim 6.
